(19) United States
(12) Patent Application Publication
(10) Pub. No.: US 2005/0069750 A1
(43) Pub. Date: Mar. 31, 2005

(54) Bipolar plate for a fuel cell

(76) Inventors: Yeong-Chan Eun, Suwon-si (KR); Ho-Jin Kweon, Suwon-si (KR); Hyoung-Juhn Kim, Suwon-si (KR); Sung-Yong Cho, Suwon-si (KR)

Correspondence Address: Robert E. Bushnell;Suite 300, 1522 K Street, N.W., Washington, DC, 20005, US

(21) Appl. No.: 10/946,326

(22) Filed: Sep. 22, 2004

(30) Foreign Application Priority Data
Sep. 26, 2003 (KR) 10-2003-0066899

(51) Int. Cl. H01M 8/02; H01M 8/10

(52) U.S. Cl. 429/38; 429/32

(57) ABSTRACT

A bipolar plate for a fuel cell which is opposed to at least one electrode and having gas fluid flow channels formed therein is made of a polymer having conductive carbon dispersed therein, the conductive carbon having an interplanar spacing d002 of more than 3.4 Å by X-ray diffraction and having a specific surface area equal to or greater than 4 m²/g. A contact area ratio between gas of the fluid flow channels of the bipolar plate and the at least one electrode is in a range of 40 to 70% of the total area of the bipolar plate.

### CLAIM OF PRIORITY

This application makes reference to, incorporates the same herein, and claims all benefits accruing under 35 U.S.C. § 119 from an application for A BIPOLAR PLATE FOR A FUEL CELL earlier filed in the Korean Intellectual Property Office on 26 Sep. 2003 and there duly assigned Serial No. 10-2003-0066899.

### BACKGROUND OF THE INVENTION

1. Field of the Invention

The present invention relates to a bipolar plate for a fuel cell, and more particularly to a bipolar plate for a fuel cell which can improve gas-providing efficiency by optimizing a contact area between gas of a fluid flow channel of a bipolar plate and electrodes, resulting in improving electric energy conversion efficiency.

2. Description of the Related Art

Fuel cells are electrochemical cells that convert energy generated by an oxidation reaction of fuel to electrical energy. Fuel cells that are currently commercialized include Phosphoric Acid Fuel Cells (PAFC) and Molten Carbonate Fuel Cells (MCFC). Polymer Electrolyte Membrane Fuel Cells (PEMFC) have also been developed as highly efficient cells.

A PEMFC comprises a Membrane Electrode Assembly (MEA) including anode and cathode electrode layers and a Polymer Electrolyte Membrane (PEM) interposed between the two electrode layers. The membrane electrode assemblies are laminated using a bipolar plate with fluid flow channels formed thereon. The fuel cell generates electrical power by respectively providing fuel and oxidation material into the anode and cathode, and generating electric power through an electrochemical reaction between the anode and cathode.

As the polymer electrolyte of a PEMFC, a fluorine-containing polymer having an ion-exchange functional group and a group such as sulfonic acid, carbonic acid, phosphoric acid, phosphorous acid, etc. is used. A fluorine-containing polymer electrolyte membrane such as a perfluoro carbon sulfonic acid membrane (Nafion™) manufactured by Dupont Company has a chemical stability, a high ionic conductivity, and good mechanical properties, and thus is generally preferred.

A voltage generated between the anode and cathode of one fuel cell is generally about 0.7V. Therefore, in order to obtain an appropriate available voltage (10V to 100V), a number of fuel cells need to be laminated together to form a stack, and adjacent fuel cells separated by bipolar plates are preferable. The bipolar plate provides an electrical connection between the cathode and anode, and it provides the cathode with a gas flow channel and has strong corrosion resistance and gas impermeability.

### SUMMARY OF THE INVENTION

It is an aspect of the present invention to provide a bipolar plate for a fuel cell which can improve gas-providing efficiency by optimizing a contact area between gas of a fluid flow channel of the bipolar plate and electrodes, resulting in improved electrical energy conversion efficiency.

It is another aspect of the present invention to provide a fuel cell including the bipolar plate for a fuel cell.

To accomplish the aspects of the present invention, the present invention provides a bipolar plate for a fuel cell, the bipolar plate comprising: a polymer having conductive carbon dispersed therein, the conductive carbon having an interplanar spacing d002 of more than 3.4 Å by X-ray diffraction and having a specific surface area equal to or greater than 4 m²/g; and gas fluid flow channels arranged therein: wherein, upon arranging the bipolar plate to be opposed to at least one electrode of the fuel cell, a contact area ratio between gas of the fluid flow channels of the bipolar plate and the at least one electrode is in a range of 40 to 70% of a total area of the bipolar plate.

The contact area ratio is preferably greater than 50% and less than 60%.

The conductive carbon is preferably present in the polymer in an amount in a range of 5 to 45 weight % on the basis of the weight of the bipolar plate.

The polymer is preferably selected from a group consisting of a fluoro-based resin, a phenol resin, and polybenzoxazine.

To accomplish the aspects of the present invention, the present invention also provides a fuel cell comprising a plurality of membrane electrode assemblies, each of the plurality of membrane electrode assemblies comprising: a cathode, an anode, and an electrolyte membrane interposed between the cathode and anode, and a bipolar plate opposed to at least one electrode and having gas fluid flow channels formed therein; the bipolar plate comprising a polymer having a conductive carbon dispersed therein, the conductive carbon having an interplanar spacing d002 of more than 3.4 Å by X-ray diffraction and having a specific surface area equal to or greater than 4 m²/g; wherein a contact area ratio between gas of the fluid flow channels of the bipolar plate and the at least one electrode is in a range of 40 to 70% of a total area of the bipolar plate.

The contact area ratio is preferably greater than 50% and less than 60%.

The conductive carbon is preferably present in the polymer in an amount in a range of 5 to 45 weight % on the basis of the weight of the bipolar plate.

The polymer is preferably selected from a group consisting of fluoro-based resin, phenol resin, and polybenzoxazine.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view of a Polymer Electrolyte Fuel Cell (PEMFC).

FIG. 2 is a plan view of a bipolar plate in accordance with an embodiment of the present invention.

### DETAILED DESCRIPTION

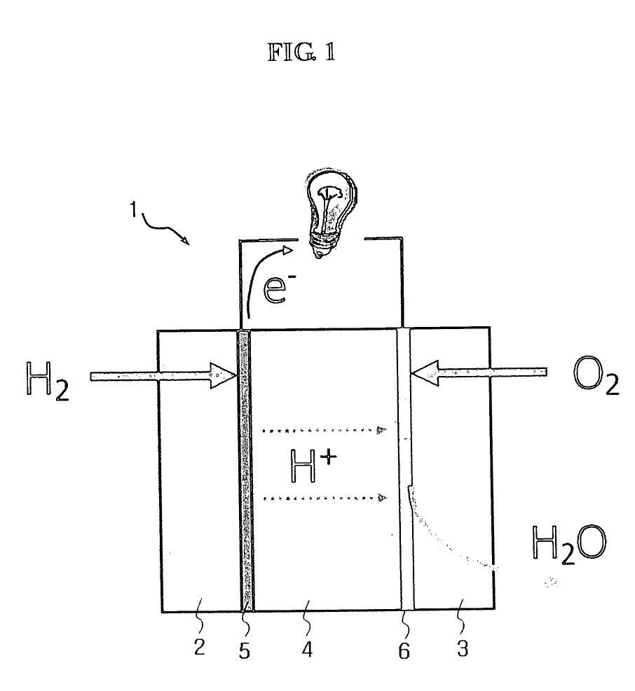

FIG. 1 illustrates a design of a PEMFC. A PEMFC 1 comprises a membrane electrode assembly (MEA) including anode 5 and cathode 6 electrode layers, and a Polymer Electrolyte Membrane (PEM) 4 interposed between the two electrode layers. The membrane electrode assemblies are laminated using bipolar plates 2 and 3 with fluid flow channels (not shown) formed thereon. The fuel cell generates electric power by respectively providing fuel (hydrogen) and oxidation material (oxygen) into the anode 5 and cathode 6 via the bipolar plates 2 and 3, and generating electrical power through an electrochemical reaction between the anode 5 and the cathode 6.

As the polymer electrolyte of a PEMFC, a fluorine-containing polymer having an ion-exchange functional group and a group such as sulfonic acid, carbonic acid, phosphoric acid, phosphorous acid, etc. is used. A fluorine-containing polymer electrolyte membrane such as a perfluoro carbon sulfonic acid membrane (Nafion™) manufactured by Dupont Company has a chemical stability, a high ionic conductivity, and good mechanical properties, and thus is generally preferred.

A voltage generated between an anode and cathode of one fuel cell is generally about 0.7V. Therefore, in order to obtain an appropriate available voltage (10V to 100V), a number of fuel cells need to be laminated together to form a stack, and adjacent fuel cells separated by bipolar plates are preferable. The bipolar plate provides an electrical connection between the cathode and anode, and it provides the cathode with a gas flow channel and has strong corrosion resistance and gas impermeability.

In the following detailed description, only an exemplary embodiment of the present invention has been shown and described, simply by way of illustration of the best mode contemplated by the inventors of carrying out the invention. As will be realized, the invention is capable of modification in various obvious respects, all without departing from the spirit and scope of the present invention. Accordingly, the drawings and description are to be regarded as illustrative in nature, and not restrictive.

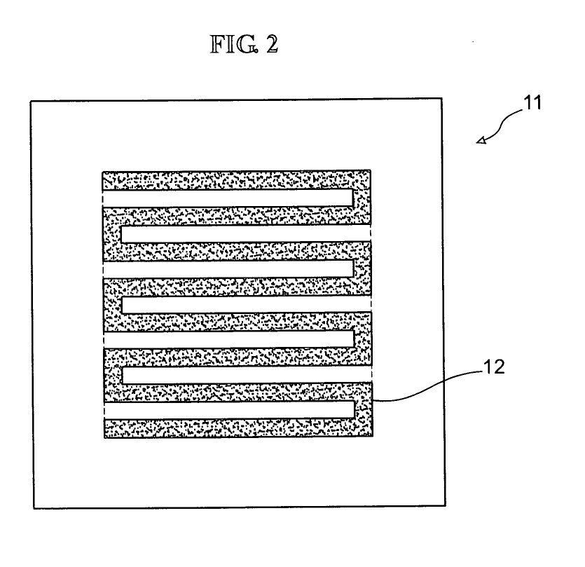

A bipolar plate of the present invention is opposed to at least one electrode of an anode and a cathode, and gas fluid flow channels are formed therein, wherein a contact area ratio between gas of the fluid flow channel of the bipolar plate and electrodes is 40 to 70%, preferably more than 50% and less than 60%, on the basis of the total area of the bipolar plate. As shown in FIG. 2, a bipolar plate 11 has a contact area 12 between gas and electrode comprising a two dimensional serpentine area of fluid flow contacting the electrode, i.e. a membrane electrode assembly, or in other words, a reaction area. When the contact area is less than 40%, gas diffusion is difficult, and when the contact area is more than 70%, there are problems in electron conductivity.

The bipolar plate is made of a polymer having conductive carbon dispersed therein, the conductive carbon having an interplanar spacing d002 of more than 3.4 Å by X-ray diffraction, and a specific surface area equal to or greater than 4 m²/g, and preferably 70 m²/g. Preferred examples include Vulcan XC-72 (specific surface area: 180 m²/g) and acetylene black (specific surface area: 70 m²/g). The carbon improves the electrical conductivity of the bipolar plate.

The carbon is preferably present in the polymer in an amount of 5 to 45 weight % on the basis of the weight of the bipolar plate. When the amount of the carbon is less than 5 weight %, electrical conductivity deteriorates, and when the amount of the carbon is more than 45 weight %, gas permeability increases, resulting in leakage of gas in the manufacture of a stack.

The polymer which is used in the manufacture of the bipolar plate includes fluoro-based resin, phenol resin, polybenzoxazine, etc. Specific examples include polytetrafluoroethylene (PTFE), polyvinylidene fluoride (PVDF), etc.

The bipolar plate is manufactured according to the following process: the mixture of conductive carbon and polymer is injected into a mold wherein a fluid flow channel is designed, followed by pressure molding or injection molding and drying. The bipolar plate can also be manufactured without using a mold according to the following process: the mixture of conductive carbon and polymer is formed into a frame of the bipolar plate and dried, and a fluid flow channel is formed through a cutting process therein.

The following examples further illustrate the present invention in detail, but are not to be construed to limit the scope thereof.

### EXAMPLE 1

20 g of Vulcan XC-72R as a conductive carbon and 80 g of a polybenzoxazine polymer were agitated for 10 hours at room temperature to obtain a homogenous mixture. The mixture was injected into a mold with a fluid flow channel designed therein, and bipolar plates were manufactured by compression-molding and drying the mixture. The fluid flow channel was designed to have 30%, 45%, 60%, and 75% of the contact area ratio between gas and electrode based on the total area of the bipolar plate. Using the bipolar plates, test cells were fabricated. The current densities of the cells were measured and are shown in Table 1.

TABLE 1

| Contact area ratio (%) | Current density (vs. 0.7 V) |
|---|---|
| 30 | 326 mA/cm² |
| 45 | 575 mA/cm² |
| 60 | 605 mA/cm² |
| 75 | 390 mA/cm² |

As shown in Table 1, the cells including bipolar plates with 45% and 60% of contact area ratio have a better current density than those including bipolar plates with 30% and 75% of contact area ratio.

The bipolar plate can improve a gas supplement ratio into the electrode and a gas diffusion into catalytic layers on the electrodes, so that the electrochemical reaction on the electrodes can occur efficiently.

While the present invention has been described in detail with reference to the an exemplary embodiment, those skilled in the art will appreciate that various modifications and substitutions can be made thereto without departing from the spirit and scope of the present invention as set forth in the appended claims.

1. A bipolar plate for a fuel cell, the bipolar plate comprising:
a polymer having conductive carbon dispersed therein, the conductive carbon having an interplanar spacing d002 of more than 3.4 Å by X-ray diffraction and having a specific surface area equal to or greater than 4 m²/g; and
gas fluid flow channels arranged therein:
wherein, upon arranging the bipolar plate to be opposed to at least one electrode of the fuel cell, a contact area ratio between gas of the fluid flow channels of the bipolar plate and the at least one electrode is in a range of 40 to 70% of a total area of the bipolar plate.

2. The bipolar plate according to claim 1, wherein the contact area ratio is greater than 50% and less than 60%.

3. The bipolar plate according to claim 1, wherein the conductive carbon is present in the polymer in an amount in a range of 5 to 45 weight % on the basis of the weight of the bipolar plate.

4. The bipolar plate according to claim 1, wherein the polymer is selected from a group consisting of a fluoro-based resin, a phenol resin, and polybenzoxazine.

5. A fuel cell comprising a plurality of membrane electrode assemblies, each of the plurality of membrane electrode assemblies comprising:
a cathode, an anode, and an electrolyte membrane interposed between the cathode and anode, and a bipolar plate opposed to at least one electrode and having gas fluid flow channels formed therein;
the bipolar plate comprising a polymer having a conductive carbon dispersed therein, the conductive carbon having an interplanar spacing d002 of more than 3.4 Å by X-ray diffraction and having a specific surface area equal to or greater than 4 m²/g;
wherein a contact area ratio between gas of the fluid flow channels of the bipolar plate and the at least one electrode is in a range of 40 to 70% of a total area of the bipolar plate.

6. The fuel cell according to claim 5, wherein the contact area ratio is greater than 50% and less than 60%.

7. The fuel cell according to claim 5, wherein the conductive carbon is present in the polymer in an amount in a range of 5 to 45 weight % on the basis of the weight of the bipolar plate.

8. The fuel cell according to claim 5, wherein the polymer is selected from a group consisting of fluoro-based resin, phenol resin, and polybenzoxazine.
